(19) United States
(12) Patent Application Publication
(10) Pub. No.: US 2006/0265108 A1
(43) Pub. Date: Nov. 23, 2006

(54) Vehicle dynamics regulation system adapted to the rolling behaviour of a vehicle

(76) Inventors: Martin Kieren, Marbach A.N. (DE); Gero Nenninger, Markgroeningen (DE); Matthew Nimmo, Ludwigsburg (DE)

Correspondence Address: KENYON & KENYON LLP, ONE BROADWAY, NEW YORK, NY, 10004, US

(21) Appl. No.: 10/553,112

(22) PCT Filed: Jun. 23, 2004
(86) PCT No.: PCT/DE04/01316

§ 371 Date: Jul. 25, 2006

(30) Foreign Application Priority Data
Jul. 11, 2003 (DE) 103 31 579.9
Dec. 17, 2003 (DE) 103 59 216.4

(51) Int. Cl. G06F 19/00

(52) U.S. Cl. 701/1; 701/70; 340/440

(57) ABSTRACT

An arrangement relating to a device and a method for stabilizing a vehicle in a situation critical to rollover, where various controller input variables are measured by a sensor system, and a rollover-stabilization algorithm intervenes in the vehicle operation with the aid of an actuator, in order to stabilize the vehicle. In order to be able to take different loading conditions of the vehicle into account, a rollover tendency of the vehicle is estimated from the relationship between a variable describing the steering behavior of the vehicle and a variable describing the roll behavior of the vehicle, and the rollover tendency is taken into account in rollover stabilization.

### FIELD OF THE INVENTION

The present invention relates to a method for stabilizing a vehicle in a situation critical to rollover, as well as to a vehicle dynamics control system for the rollover stabilization of a vehicle.

### BACKGROUND INFORMATION

Vehicles having a high center of gravity, such as minivans, SUV's (sport utility vehicles), or vans, are prone to rolling over about the longitudinal axis, in particular when cornering at a transverse acceleration that is too high. Therefore, in the case of such vehicles, rollover stabilization systems, such as ROP (Rollover Prevention) or ROM (Rollover Mitigation) are used, which stabilize the vehicle in situations critical to driving dynamics and reduce the tilting motion of the vehicle about the longitudinal axis. A vehicle dynamics control system having an ROP function is shown by way of example in FIG. 1.

### SUMMARY OF THE INVENTION

FIG. 1 shows a highly simplified schematic block diagram of a known ROP system, which essentially includes a control unit 1 having an ROP control algorithm, a sensor system 2 for detecting a driving condition critical to rollover, and an actuator 3 for executing a stabilization action. If control unit 1 detects a situation critical to rollover on the basis of the sensor signals, then, for example, intervention in the vehicle operation is undertaken by actuating the brake at the front wheel on the outside of the curve. Other systems also intervene in the vehicle operation with the aid of different actuators, such as an active spring-and-shock-absorber system (normal-force distribution system) or an active steering system.

In known rollover stabilization systems, a situation critical to rollover is usually detected by ascertaining a variable describing the lateral-motion dynamics of the vehicle (which is referred to below as indicator variable S) and monitoring it with regard to a threshold value. That is, the indicator variable is compared to a characteristic threshold value, and a stabilization action is executed when the threshold value is exceeded. Usually, the indicator variable also determines the intensity of the stabilization action.

As a rule, the indicator variable is a function of transverse acceleration ay, the change in the transverse acceleration of the vehicle with respect to time day/dt, and, if indicated, other influence variables P.

FIG. 2 shows the different input variables, which enter into the calculation of indicator variable S. As can be seen, input variables ay, day/dt, P are linked according to a function 4, and indicator variable S is calculated from it. In the end, indicator variable S acquired in this manner is supplied to control algorithm 5. The enabling and the deactivation of rollover-stabilization algorithm 5 are therefore linked to the magnitude of the transverse acceleration and it's gradients.

In addition to being a function of the structural characteristics of the vehicle, the rollover behavior of a vehicle is substantially a f unction of the loading. Furthermore, structural features, such as the suspension, can change with age and consequently have an effect on the rollover tendency of the vehicle. Such effects are not considered in the vehicle dynamics control system represented in FIG. 1, which has an ROM or ROP rollover-stabilization function.

Therefore, known rollover-stabilization functions ROP or ROM are often very sensitive, in particular for SUV's or minivans, that is, adjusted to states of high loading and a soft suspension. Thus, a stabilization action is already triggered at very low transverse-acceleration values. The disadvantage of this is that at normal or low loadings, the rollover-stabilization actions take place too early and too intensely.

Therefore an object of the present invention is to provide a rollover-stabilization method for vehicles, as well as a corresponding vehicle-dynamics control system, with the aid of which the roll behavior of the vehicle may be learned in a simple and reliable manner, and therefore, a different loading or a different technical condition of the vehicle may be considered within the scope of rollover stabilization.

An essential aspect of the present invention is to estimate information regarding the rollover tendency (in the following, simply “rollover tendency”) of a vehicle from a variable describing the steering behavior (e.g. the steering angle or the steering speed and a variable describing the roll behavior (e.g. the roll rate or the compression travel), and to adjust the rollover-stabilization system to the rollover tendency ascertained in this manner. The rollover tendency of the vehicle is preferably learned anew after each start (ignition on) of the vehicle, in the course of vehicle operation, and is taken into account in the rollover stabilization system.

The evaluation of the relationship between the variable describing the steering behavior (referred to below as the steering variable) and the variable describing the roll behavior (referred to below as the roll variable) has the advantage that the rollover tendency (or roll stability) of the vehicle may be estimated in a particularly reliable manner, and therefore, different loading conditions or a modified technical condition may be considered in the vehicle-dynamics control system.

For example, the ascertained rollover tendency may directly enter into the calculation of indicator variable S and, therefore, influence the triggering time or deactivation time of the stabilization action.

As an option, the information regarding the rollover tendency may also enter into the rollover-stabilization algorithm and influence a characteristic property or variable of the algorithm, such as a control threshold value, a control deviation, e.g. for a wheel slip, or a controlled variable, such as the braking torque or the engine torque. Therefore, the named, characteristic properties or variables are a function of the rollover tendency. Therefore, in the case of a high rollover tendency, i.e. a high center of gravity or a poor suspension, a stabilization action may be initiated earlier or to a greater degree than in the case of a lower rollover tendency.

To determine the rollover tendency of the vehicle, both the static and dynamic relationships between a steering and a roll variable may be evaluated. At least dynamic driving situations, such as dynamic cornering, are preferably evaluated with regard to the rollover tendency, and therefore, the actual rollover tendency of the vehicle is determined more and more accurately in the course of the drive.

The steering variable is, in particular, the (measured) steering angle or a variable derived from it, such as the steering speed. The roll variable includes, for instance, the contact patch forces of the wheels, the compression travel for individual wheels, the vertical acceleration or the roll angle, or variables derived from them, such as the change in the compression travel or the roll rate (change in the roll angle).

In a steady-state driving situation, the relationship between the steering angle and a static roll variable, such as the compression travel of individual wheels, is evaluated, and a rollover tendency is estimated from it.

In a dynamic driving situation, e.g. the relationship between the steering speed and a dynamic roll variable, such as the roll rate, is evaluated.

In addition to a purely static or dynamic analysis, the dynamic change in aroll variable may also be evaluated in a steady-state driving situation. For example, during steady-state cornering, a vehicle displays a variable oscillatory characteristic about the longitudinal axis as a function of the loading condition or the condition of the suspension. Therefore, the rollover tendency or roll stability of the vehicle may also be estimated by evaluating the amplitude and/or frequency of oscillation of a roll variable versus time.

According to a preferred specific embodiment of the present invention, a rollover indicator, which indicates the rollover tendency of the vehicle, is ascertained from the steering and roll variables, using fuzzy logic.

The rollover indicator may additionally be weighted by a weighting function, which takes into account the quality of the learning event and is therefore a measure of the reliability of the calculated rollover indicator. In this context, the weighting function preferably weights the number of learning events and/or their duration during a trip. This particularly ensures that the rollover tendency is not incorrectly underestimated under difficult estimation conditions.

The rollover tendency is preferably only estimated in predetermined driving situations, which satisfy, for example, certain specified conditions regarding the steering angle, transverse acceleration or another variable describing the lateral-motion dynamics of a vehicle. Consequently, it is ensured that the result of the estimation is as reliable as possible.

After the vehicle is restarted, the rollover tendency, i.e. the rollover indicator is preferably initialized to have a value, which represents a high rollover tendency of the vehicle and therefore produces an early and rather intense action of the rollover-stabilization algorithm. A rollover indicator, which represents the actual loading state, first sets in with increasing driving time and, therefore, after several learning phases.

If considerably different rollover indicators are ascertained within one or more learning phases (driving situations), the one representing the highest rollover tendency is preferably selected and made the basis of the vehicle stabilization.

### BRIEF DESCRIPTION OF THE DRAWINGS

FIG. 1 shows a schematic block diagram of a known rollover-stabilization system.

FIG. 2 shows a schematic representation of the calculation of an indicator variable S of a rollover-stabilization algorithm.

FIG. 3 shows a block diagram of a rollover-stabilization system according to a specific embodiment of the present invention.

FIG. 4 shows a block diagram for representing the generation of a rollover indicator K1.

### DETAILED DESCRIPTION

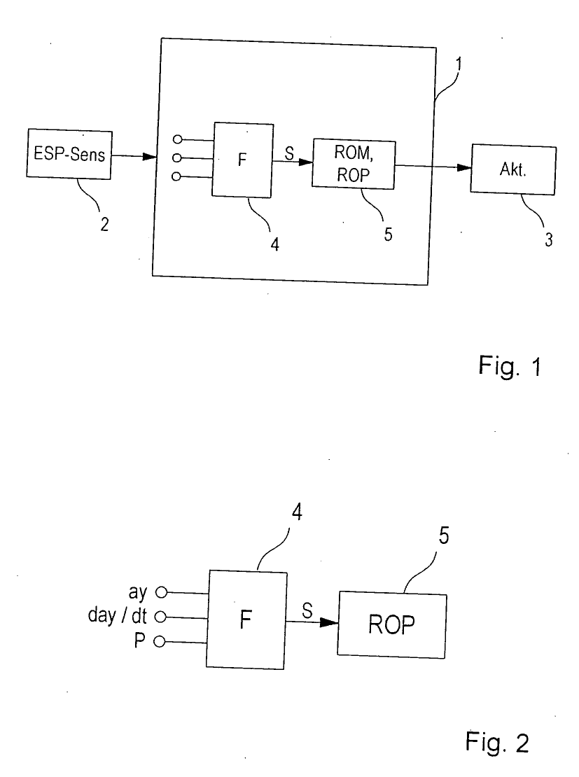

Reference is made to the introductory part of the specification regarding the clarification of FIGS. 1 and 2.

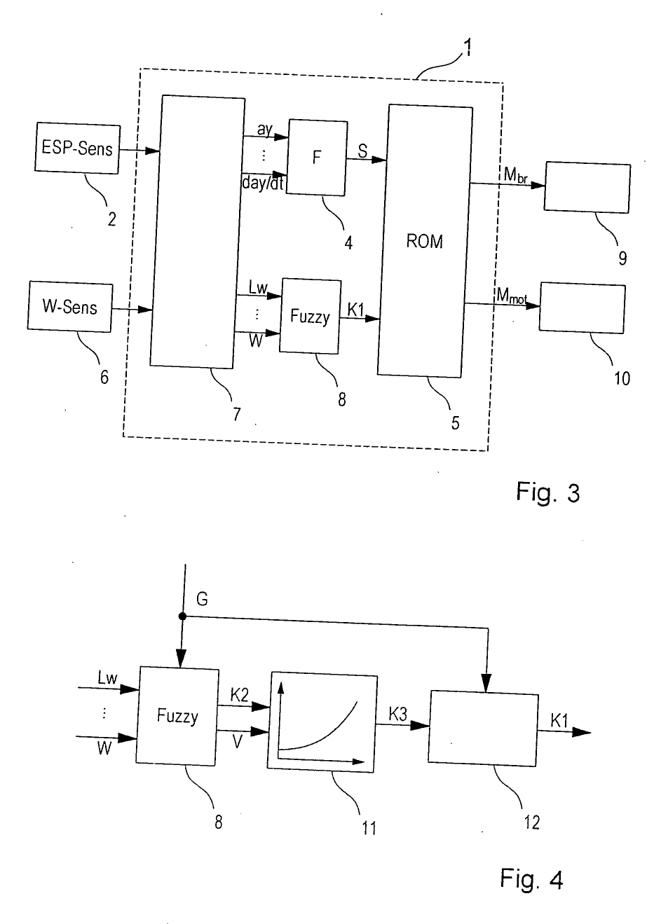

FIG. 3 shows a schematic block diagram of a rollover-stabilization system. The system includes a control unit 1 having a rollover-stabilization algorithm ROM (rollover mitigation), a sensor system 2, 6 for measuring driving-condition variables, and actuators 9, 10, with the aid of which stabilization actions are implemented. Blocks 4, 7, 8 are implemented in the form of software and are used for processing the sensor signals (block 7), estimating the rollover tendency or roll stability of the vehicle (block 8), and generating an indicator variable S (block 4).

The rollover-stabilization system uses the ESP sensor system 2 already present to determine a driving situation critical to rollover. The ESP sensor system includes, in particular, wheel-speed sensors, a steering-angle sensor, a transverse-acceleration sensor, etc. The sensor signals are processed further in block 7, and, in the process, they are particularly rendered free of interference and filtered. A plausibility check of the sensor signals is preferably carried out, as well.

Selected signals, namely transverse acceleration ay, its gradient day/dt, and, if applicable, further influence variables P enter into block 4. As explained above with regard to FIG. 2, an indicator variable S, by which the enabling or deactivation of stabilization measures is controlled, is calculated in block 4. In this context, the indicator variable also determines the intensity of the stabilization action.

In addition to ESP sensor system 2, the rollover-stabilization system may include an additional sensor system 6 for measuring a roll variable. Therefore, sensor system 6 may include, for example, a sensor for measuring the contact patch forces of the wheels, the compression travel, the vertical acceleration, or the roll rate, or a variable derived from them, such as the respective gradient. The sensor signals are processed in block 7 and then supplied to fuzzy-information processing unit 8. Block 8 receives at least a steering variable and a roll variable as input variables.

The steering variable is, in particular, (measured) steering angle Lw or a variable derived from it, such as steering speed dLw/dt. Roll variable W includes, e.g. the contact patch forces of the wheels, the compression travel, the vertical acceleration, or the roll angle, or variables derived from them, such as the change in the compression travel or the roll rate (change in the roll angle).

Fuzzy-information processing unit 8 is capable of evaluating both a static and a dynamic relationship between a steering and a roll variable W and ascertaining, from this, a rollover indicator K1 which indicates the rollover tendency or the roll stability of the vehicle. In the case of a steady-state analysis of a driving situation, e.g. the relationship between the steering angle and a static roll variable W, such as the compression travel, is evaluated, and a rollover tendency is estimated from it. In the case of a dynamic analysis, e.g. the connection between the steering speed and a dynamic roll variable W, such as the roll rate, is evaluated.

Block 8 includes a fuzzy-information processing unit, by which the relationship between the steering and roll variables is modeled, and the rollover tendency or roll stability of the vehicle is estimated from the combination of the individual variables. Within the scope of the fuzzy approximation inside of block 8, a finite amount of linguistic values, which are assigned fuzzy amounts, is defined, in each instance, on the base amounts of a steering variable Lw and a roll variable W. Together with the control basis, which models the relationship between individual linguistic values of the steering variable and the roll variable, they represent the expert knowledge regarding the relationship between driver input and roll dynamics as a function of the height of the center of gravity.

With the aid of the processing steps “fuzzification” and “inference” known from fuzzy logic, the steering and roll variables are modeled on the linguistic variable “change in the height of the center of gravity”. The base amount of these variables is made up of, e.g. the linguistic values “unchanged”, “slightly elevated”, and “sharply elevated” (with respect to normal loading). Defuizzification ultimately provides one with rollover indicator K1, e.g. in the interval, which is a measure of the current rollover tendency of the vehicle. Rollover indicator K1 may assume, e.g. values between 0: height of center of gravity unchanged, i.e. normal rollover tendency, and 1: height of center of gravity sharply elevated, i.e. high rollover tendency. Instead of modeling the rollover tendency on a continuous base amount, categorization into several discrete classes is also conceivable (“fuzzy classification”).

In addition to the purely static or dynamic analysis, e.g. the dynamic change in a roll variable W may also be evaluated in a static driving situation. During study-state cornering, a vehicle displays a variable oscillatory characteristic about the longitudinal axis as a function of the loading condition or the condition of the suspension. Therefore, the rollover tendency or roll stability of the vehicle may also be estimated by analyzing the amplitude and/or frequency of oscillation of a roll variable at a fixed steering angle.

Resulting rollover indicator K1 is now used for changing characteristic properties or variables of rollover-stabilization algorithm 5 or modifying the intensity of a stabilization action in accordance with the rollover tendency. To this end, e.g. the control threshold of the algorithm, the permissible control deviation of a controlled variable, such as a wheel slip, or an internally calculated, controlled variable may be changed.

As an option, indicator variable S may also be calculated as a function of the rollover tendency. In addition, an increased rollover tendency and, therefore, an increased risk of rollover may also be indicated to the driver, using, for example, a signal lamp in the instrument cluster.

FIG. 4 shows a specific embodiment of an algorithm for estimating rollover indicator K1, using fuzzy-information processing unit 8. The estimation method is only implemented in predetermined, favorable driving situations, i.e. in those situations that are very meaningful to the estimation. For this purpose, fuzzy algorithm 8 is supplied specified, driving-dynamics variables G, with the aid of which the driving situation may be analyzed. If driving-dynamics variables G, such as a transverse acceleration or a steering speed, satisfy at least one specified condition, then fuzzy algorithm 8 is activated or deactivated.

In addition, a confidence variable V is generated, which analyzes the quality of the estimation and, therefore, the reliability of rollover indicator 2. Confidence variable V may take into account, e.g. the number of learning events and/or the period of time during a trip.

Rollover indicator K2 generated by fuzzy-information processing unit 8 and confidence variable V are then linked to one another by a characteristics map 11. Qualitatively speaking, when the values of confidence variables V are low (e.g. V=0), the combination generates high values for resulting rollover indicator K3 (i.e. high risk of rollover), and when the values of confidence variable V are high (e.g. V=1), then the combination generates a rollover indicator, where K3=K2. Therefore, depending on the quality of the estimation, rollover indicator K2 ascertained by fuzzy-information processing unit 8 is either retained, i.e. K3=K2, or increased in the direction of more critical values.

Rollover indicator K3 is finally supplied to an initialization and filter unit 12. Unit 12 is set up in such a manner, that after every restart of the vehicle, it outputs a starting value for rollover indicator K1, which, for reasons of safety, has a relatively high value, such as K1=1.

Therefore, this value produces a sensitive setting of stabilization algorithm 5. In some instances, rollover indicator K1 decreases during the drive.

Unit 12 is also used for filtering estimated values K3 determined during a drive and taking resulting value K1 as a basis for the rollover stabilization. The filtering is preferably implemented as the generation of the maximum of all estimated values K3 versus time, or as a moving average over a specific number of estimated values.

Unit 12 is also set up in such a manner, that in the case of longer trips not having sufficient learning phases, such as trips on a highway not having curves, rollover indicator K1 is increased to a higher value, which represents a higher rollover tendency and therefore results in more sensitive control of stabilization algorithm 5. Unit 12 is likewise activated or deactivated as a function of specified driving-dynamics variables G.

The above-described set-up allows a particularly accurate and reliable estimation of the rollover tendency of a vehicle, by both aesthetically and dynamically analyzing the relationship between a steering and a roll variable.

### LIST OF REFERENCE NUMERALS

| | |
|---|---|
| 1 | control unit |
| 2 | ESP sensor system |
| 3 | actuator system |
| 4 | function for calculating an indicator variable |
| 5 | rollover-stabilization algorithm |
| 6 | roll-variable sensor system |
| 7 | signal processing and monitoring |
| 8 | fuzzy-information processing unit |
| 9 | brake system |
| 10 | engine management |
| 11 | characteristics map |
| 12 | initialization and filter unit |
| ay | transverse acceleration |
| day/dt | change in the transverse acceleration |
| P | influence variables |
| Lw | steering variable |
| W | roll variable |
| K1, K2, K3 | rollover indicators |
| S | indicator variable |

1-11. (canceled)

12. A method for a rollover stabilization of a vehicle in a critical driving situation, comprising:
measuring different driving-condition variables by a sensor system;
causing an actuator to intervene with a rollover-stabilization algorithm in a vehicle operation in a situation critical to rollover, in order to stabilize the vehicle; and
estimating information from a relationship between a steering variable and a roll variable, the information relating to a rollover tendency of the vehicle and being taken into account in a scope of the rollover stabilization.

13. The method as recited in claim 12, further comprising:
ascertaining one of an indicator variable and one of a characteristic property and a variable of the rollover stabilization as a function of the rollover tendency, wherein:
a stabilization action is one of enabled and deactivated in accordance with the indicator variable.

14. The method as recited in claim 12, wherein the steering variable includes one of a steering angle and a steering speed.

15. The method as recited in claim 12, wherein the roll variable includes one of contact patch forces of wheels, a compression travel, a vertical acceleration, a roll angle, and a roll rate.

16. The method as recited in claim 12, further comprising:
changing, as a function of the rollover tendency, one of a control threshold of the rollover-stabilization algorithm, a control deviation, and a controlled variable of the rollover-stabilization algorithm.

17. The method as recited in claim 12, further comprising:
ascertaining, from the steering variable and the roll variable, a rollover indicator indicating the rollover tendency of the vehicle.

18. The method as recited in claim 17, wherein the rollover indicator is determined by a fuzzy-information processing unit.

19. The method as recited in claim 18, further comprising:
weighting the rollover indicator by a weighting function indicating a quality of an estimation of the rollover indicator.

20. A vehicle-dynamics control system for a rollover stabilization of a vehicle in a critical driving situation, comprising:
a control unit for storing a rollover-stabilization algorithm;
a sensor system for measuring current, actual values of the control system;
an actuator for executing a stabilization action, wherein:
the sensor system ascertains a roll variable and a steering variable; and
a device for estimating a rollover tendency of the vehicle from the steering variable and the roll variable, the rollover tendency being taken into account in a scope of the rollover stabilization.

21. The vehicle-dynamics control system as recited in claim 20, wherein the control unit ascertains one of an indicator variable, with the aid of which a stabilization action is one of enabled and deactivated, a characteristic property, and a variable of the rollover-stabilization algorithm, as a function of the rollover tendency.

22. The vehicle-dynamics control system as recited in claim 20, wherein the sensor system includes a roll-rate sensor for ascertaining the roll variable.
